(19) United States
(12) Patent Application Publication
(10) Pub. No.: US 2023/0024249 A1
(43) Pub. Date: Jan. 26, 2023

(54) INFORMATION COOPERATION DEVICE, INFORMATION COOPERATION METHOD, AND INFORMATION COOPERATION PROGRAM

(71) Applicant: Nippon Telegraph and Telephone Corporation, Tokyo (JP)

(72) Inventors: Hidetaka Koya, Musashino-shi, Tokyo (JP); Takeshi Masuda, Musashino-shi, Tokyo (JP); Akira Kataoka, Musashino-shi, Tokyo (JP); Masashi Tadokoro, Musashino-shi, Tokyo (JP); Makoto Komiyama, Musashino-shi, Tokyo (JP)

(21) Appl. No.: 17/766,417

(22) PCT Filed: Oct. 9, 2019
(86) PCT No.: PCT/JP2019/039867

§ 371 Date: Apr. 4, 2022

(51) Int. Cl. G06Q 10/06

(52) U.S. Cl. CPC G06Q 10/063114

(57) ABSTRACT

A storage unit (21) stores, for each extended user interface, a work determination method (21a) that is a method for determining a work that is carried out by a user, and work data (21b) that has been input to the extended user interface in correspondence with the work. A work determination unit (12b) acquires the work determination method (21a) for an extended user interface that is displayed, from the storage unit (21), and determines the work that is carried out by the user on a terminal (10) that is operated by the user, according to the work determination method (21a). A work data processing unit (12c) acquires the work data (21b) corresponding to the determined work, from the storage unit (21), and displays it on the extended user interface.

### TECHNICAL FIELD

The present invention relates to an information linkage system and an information linkage method.

### BACKGROUND ART

In recent years, solutions have been developed to support team collaboration and improve productivity. However, in highly specialized work such as network operation by telecommunications carriers, it is difficult to improve team productivity with related solutions because most of the work in the day is performed on a specially developed system. On the other hand, in order to improve the efficiency of work using such a dedicated system, UI extension technologies (see Patent Literature 1 and Non Patent Literature 1) have been developed that realize productive work by adding an extended user interface (UI, User Interface) whose system screen has various functions such as an input check function, without modifying the existing system.

### CITATION LIST

### Patent Literature

[Patent Literature 1] Japanese Laid-open Patent Publication No. 2018-5344

### Non Patent Literature

[Non Patent Literature 1] Kenichi Nishikawa and 5 others, “A Method for Attaching Additional Functionalities onto web-based OSS User Interfaces”, IEICE technical report, Institute of Electronics, Information and Communication Engineers

### SUMMARY OF THE INVENTION

### Technical Problem

However, there is a problem that the related UI extension technologies cannot realize the extended UI for improving team productivity. For example, data entered by an operator in the extended UI added later to the system screen is treated as temporary data, and is not retained persistently in the database (DB) of the existing system, and other operators cannot refer to information. Therefore, it is difficult to perform information linkage between a plurality of operators, using the extended UI.

The present invention has been made in view of the above, and an objective is to make it possible to link information input to the extended UI between a plurality of operators, thereby linking information between operators on the screen of the dedicated system that the operators use on a daily basis, and improving team productivity.

### Means for Solving the Problem

To solve the above problem and achieves the objective, an information linkage system according to the present invention includes: a storage unit that stores, for each extended user interface, a work determination method that is a method for determining a work that is carried out by a user, and work data that has been input to the extended user interface in correspondence with a work; a work determination unit that acquires the work determination method for an extended user interface that is displayed, from the storage unit, and determines the work that is carried out by the user on a terminal that is operated by the user, according to the work determination method; and a work data processing unit that acquires the work data corresponding to the work thus determined, from the storage unit, and displays the work data on the extended user interface.

### Effects of the Invention

According to the present invention, it is possible to link information input to the extended UI between a plurality of operators, and improve team productivity.

### BRIEF DESCRIPTION OF DRAWINGS

FIG. 1 is a schematic diagram illustrating an overall configuration of an information linkage system according to an embodiment.

FIG. 2 is a diagram illustrating a data structure of a work determination method.

FIG. 3 is a diagram illustrating a data structure of a work database that includes work data.

FIG. 4 is a diagram illustrating processing that is carried out by a work data processing unit.

FIG. 5 is a diagram illustrating processing that is carried out by a work determination unit and the work data processing unit.

FIG. 6 is a diagram illustrating processing that is carried out by the work determination unit and the work data processing unit.

FIG. 7 is a diagram illustrating processing that is carried out by the work determination unit and the work data processing unit.

FIG. 8 is a diagram illustrating processing that is carried out by the work determination unit.

FIG. 9 is a diagram illustrating processing that is carried out by the work determination unit.

FIG. 10 is a flowchart showing information linkage processing procedures.

FIG. 11 is a diagram illustrating advantages of information linkage processing according to the embodiment.

FIG. 12 is a diagram illustrating advantages of information linkage processing according to the embodiment.

FIG. 13 is a diagram illustrating advantages of information linkage processing according to the embodiment.

FIG. 14 is a diagram illustrating advantages of information linkage processing according to the embodiment.

FIG. 15 is a diagram showing an example of a computer that executes an information linkage program.

### DESCRIPTION OF EMBODIMENTS

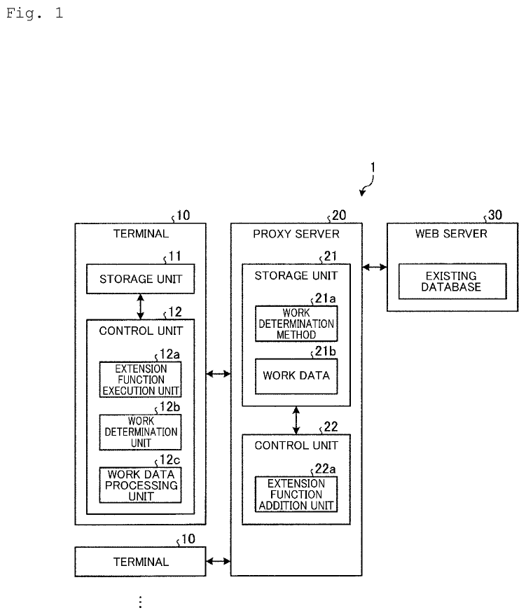

Hereinafter, an embodiment of the present invention will be described in detail with reference to the drawings. Note that the present invention is not limited to the embodiment. In addition, in the description of the drawings, the same parts are indicated by the same reference numerals.

[Configuration of Information Linkage System] FIG. 1 is a schematic diagram illustrating an overall configuration of an information linkage system according to the present embodiment. As shown in FIG. 1, an information linkage system 1 according to the present embodiment includes terminals 10, a proxy server 20, and a web server 30. There are a plurality of terminals 10, and operators, which are users, operate their respective terminals 10. The web server 30 is, for example, a server device for a work system such as a web system, and communicates with each terminal 10 via a web browser running on the terminal 10.

The proxy server 20 relays communication between the terminals 10 and the web server 30. In the present embodiment, the proxy server 20 adds an extended UI to the web browser of each terminal 10. In addition, the proxy server 20 stores and manages work data input by the user of each terminal 10 to the extended UI thereof, as will be described later.

[Configuration of Proxy Server] The proxy server 20 is realized using a general-purpose computer such as a personal computer or a workstation, and includes a storage unit 21 and a control unit 22.

The storage unit 21 is realized using a semiconductor memory device such as a RAM (Random Access Memory) or a flash memory, or a storage device such as a hard disk or an optical disk. The storage unit 21 stores in advance a processing program that operates the proxy server 20, data used during execution of the processing program, for example, or temporarily stores them each time processing is performed.

In the present embodiment, the storage unit 21 stores a work determination method 21a and work data 21b that are to be applied to information linkage processing described later.

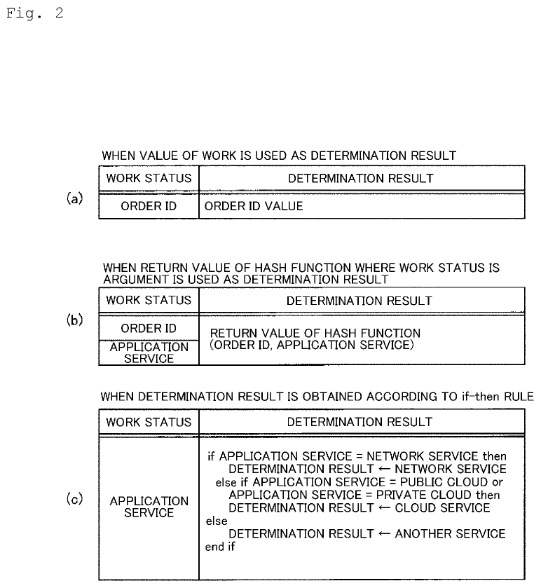

The work determination method 21a is information that specifies a method that is to be used to determine the work that is carried out by the user, for each extended UI. Here, FIG. 2 is a diagram illustrating a data structure of the work determination method 21a. The work determination method 21a is set for each extended UI, and includes a work status and a determination result as shown in FIG. 2.

Specifically, a work status is information that is to be used to determine a work that is carried out by a user, and that specifies the surrounding environment of the user. The surrounding environment is specified by, for example, any of, or a combination of: information regarding the terminal 10; information displayed on the screen of the terminal 10; and information regarding another application running on the terminal 10. In the example shown in FIG. 2, the work status is an order ID (a), an application service (c), or the combination of the order ID and the application service (b) that are displayed on the same system screen.

The determination result is, as shown in FIG. 2, for example, a value (a) of the aforementioned work status, a return value (b) of a hash function where the work status is an argument, or a value (c) specified by an if-then rule. In the information linkage processing described later, the work that is carried out by the user is determined using the determination result.

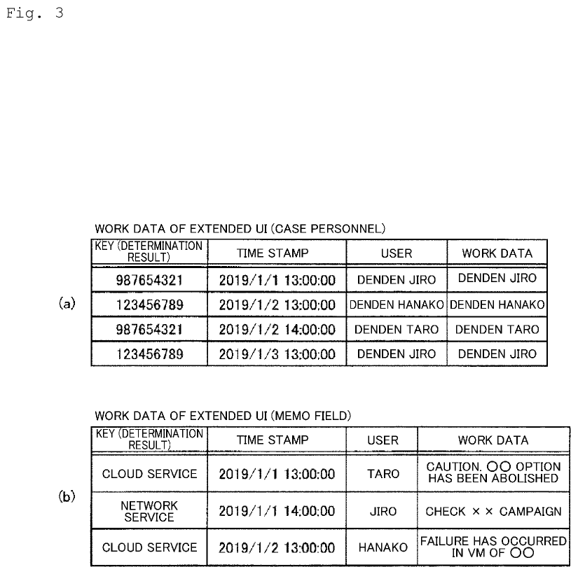

The work data 21b is information input to the extended UI in correspondence with a work. FIG. 3 is a diagram illustrating a data structure of a work database that includes the work data 21b. As shown in FIG. 3, the work database stores the work data 21b for each extended UI, using, as a key, the determination result of the work determination method specified as described above. That is to say, the work database stores the work data 21b in association with the work.

In addition, the work database stores work data 21b in association with information that identifies the user and time (a time stamp). The information that identifies the user, such as the user name displayed on the system screen or the user name used when the user logs in to the system of the terminal 10, may be acquired from the user's surrounding environment. In the information linkage processing described later, the work data 21b transmitted from the terminals 10 in association with these pieces of information is stored in the storage unit 21.

FIG. 3(a) illustrates a work database that includes the work data 21b of the extended UI for a “case personnel”. This work database includes, for example, a record in which the determination result for the work status “order ID” is “123456789”, the time stamp is “2019/1/3 13:00:00”, the user is “Denden Jiro”, and the work data is “Denden Jiro”.

FIG. 3(b) illustrates a work database that includes the work data 21b of the extended UI for a “memo field”. This work database includes, for example, a record in which the determination result for a work status “application service” is “cloud service”, the time stamp is “2019/1/1 13:00:00”, the user is “Taro”, and the work data is “Caution. ∘∘ option has been abolished”.

FIG. 1 will be described again. The control unit 22 is realized using a CPU (Central Processing Unit) or the like, and executes a processing program stored in a memory. As a result, the control unit 22 functions as an extension function addition unit 22a as illustrated in FIG. 1. The extension function addition unit 22a instructs the web browser of the terminal 10 to display the extended UI. Note that the control unit 22 may include another functional unit.

The configuration including the storage unit 21 and the control unit 22 is not limited to the configuration that realizes the extension function addition unit 22a through the method of insertion into the HTTP response returned from the web server 30 by the proxy server 20 as shown in FIG. 1. For example, any method can be selected, such as a method through which insertion is performed by a local application running on the terminal 10 using a library such as MSHTML, or a method through which insertion is performed by an add-on function of the web browser that displays a system screen on the terminal 10. In addition, the storage unit 21 need only be able to be accessed and controlled by a work data processing unit 12c and the control unit 22, and need not be arranged on the same proxy server 20. Also, the storage unit 21 may be realized as a database that operates on the web server 30, or may be realized as a file in a shared folder.

[Configuration of Terminal] The terminal 10 is realized using a general-purpose computer such as a personal computer, and includes a storage unit 11 and a control unit 12. In addition, the terminal 10 includes an input unit and an output unit, which are not shown. The input unit is realized using an input device such as a keyboard or a mouse. The output unit is realized using a display device such as a liquid crystal display, and displays a screen of a website or the like via a web browser.

The storage unit 11 is realized using a semiconductor memory device such as a RAM (Random Access Memory) or a flash memory, or a storage device such as a hard disk or an optical disk. The storage unit 11 stores in advance a processing program that operates the terminal 10, data used during execution of the processing program, for example, or temporarily stores them each time processing is performed. The storage unit 11 may be configured to communicate with the control unit 12 via a communication control unit, which is not shown.

The control unit 12 is realized using a CPU (Central Processing Unit) or the like, and executes a processing program stored in a memory. As a result, the control unit 12 functions as an extension function execution unit 12a, a work determination unit 12b, and a work data processing unit 12c as illustrated in FIG. 1. Note that each or some of these functional units may be realized as a different piece of hardware. Note that the control unit 12 may include another functional unit.

The extension function execution unit 12a displays an instructed extended UI. Specifically, the extension function execution unit 12a displays an extended UI on a web browser according to an instruction from the extension function addition unit 22a of the proxy server 20.

The work determination unit 12b acquires the work determination method 21a of the displayed extended UI from the storage unit 21 of the proxy server 20, and determines the work that is carried out by the user on the terminal 10 that is operated by the user, according to the work determination method.

Specifically, the work determination unit 12b first references the work determination method 21a by accessing the storage unit 21 of the proxy server 20, and acquires the work determination method 21a of the displayed extended UI. Thereafter, the work determination unit 12b uses the work status value set to the work determination method 21a, to obtain the determination result corresponding to the work that is carried out by the user.

For example, in the work determination method 21a illustrated in FIG. 2, when the work status is “order ID”, the work determination unit 12b acquires the work status value “order ID value” and obtains the determination result “order ID value”. Alternatively, when the work status is “order ID, application service”, the work determination unit 12b acquires the work status value “order ID value, application service value”, and obtains the determination result “return value of hash function(order ID, application service)”.

The work data processing unit 12c acquires the work data 21b corresponding to the determined work, from the storage unit 21 of the proxy server 20, and displays it on the extended UI. Specifically, the work data processing unit 12c accesses the storage unit 21 of the proxy server 20, references the work database that includes the work data 21b of the displayed extended UI, using the determination result as a key, and acquires a record that matches the determination result. Thereafter, the work data processing unit 12c displays the work data 21b of the acquired record, on the extended UI.

For example, the work data processing unit 12c acquires a record with the determination result “order ID value=123456789” from the work database that includes the work data 21b of the extended UI for “case personnel” illustrated in FIG. 3 (a).

Thereafter, the work data processing unit 12c appropriately formats the pieces of work data of this record, “Denden Hanako” and “Denden Jiro”, according to the purpose of the extended UI, and displays them on the extended UI for the “case personnel”. For example, the work data processing unit 12c displays the work data 21b of the latest record among a plurality of records that have the same determination result (in the case of “reference” described later). Alternatively, the work data processing unit 12c displays a plurality of pieces of work data 21b that have the same determination result, in chronological order or with a time added thereto (in the case of “reference all” described later).

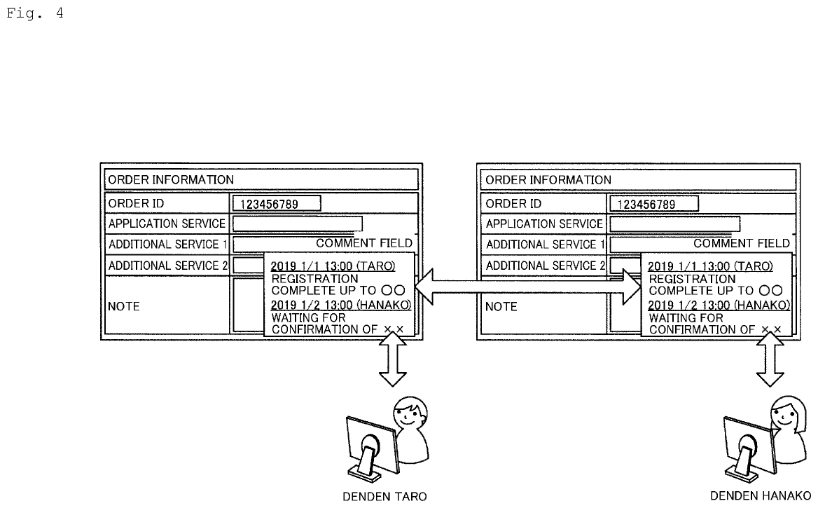

For example, FIG. 4 is a diagram illustrating processing that is carried out by the work data processing unit 12c. The example shown in FIG. 4 illustrates the extended UI for the “comment field”, in which the work status of the work determination method 21a is “order ID” and the determination result is “order ID value”. In this case, the pieces of work data “registration complete up to 00” and “waiting for confirmation of xx” of the plurality of records that have the same determination result “12345678” are displayed in the extended UI for “comment field”, and the user and time are noted in each piece of work data. In this way, a plurality of operators “Denden Taro” and “Denden Hanako” can share the same work data in the “comment field”.

Also, the work data processing unit 12c stores, in the storage unit 21 of the proxy server 20, the work data input by the user to the extended UI during execution of work, in association with the work (in the case of “save” described later). For example, when the user inputs “Denden Jiro” in the extended UI for “case personnel”, the work data processing unit 12c transmits this piece of work data “Denden Jiro” to the proxy server 20 in association with the work that is in execution, i.e., the determination result, and stores it in the storage unit 11.

At that time, the work data processing unit 12c stores work data in the storage unit 21 of the proxy server 20 further in association with information that identifies the user, and time (a time stamp). As described above, information that identifies the user, such as the user name at the time the user logs in to the terminal 10 or the system, may be acquired from the user's surrounding environment.

Note that, when the latest piece of work data of pieces of work data 21b corresponding to the determined work is a piece of work data input by another user, the work data processing unit 12c may provide a notification of a change in work data. For example, the work data processing unit 12c additionally displays new work data added by a user other than the user operating the terminal, on the extended UI, with the user and time added.

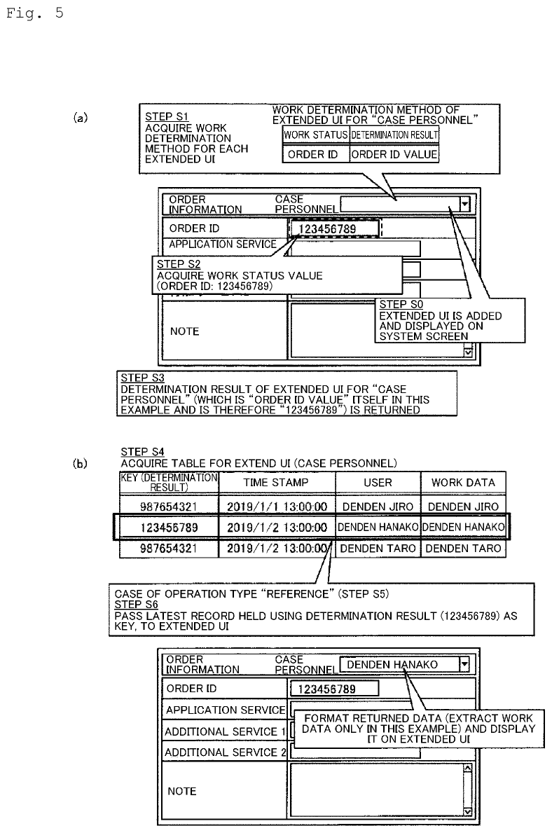

Here, FIGS. 5 to 7 are diagrams illustrating processing that is carried out by the work determination unit 12b and the work data processing unit 12c. First, FIG. 5 illustrates processing that is carried out when the operation type of the operation performed by the user on the extended UI for “case personnel” is “reference”.

First, the user has performed an operation to make an instruction indicating “reference” to the extended UI for “case personnel” that is additionally displayed on the system screen by the extension function execution unit 12a (step S0). In this case, the work determination unit 12b acquires the work determination method 21a of the displayed extended UI for “case personnel” from the storage unit 21 of the proxy server 20 (step S1).

Also, the work determination unit 12b acquires the work status value set to the work determination method 21a (step S2). In the example shown in FIG. 5, the work determination unit 12b acquires the value “123456789” of the work status “order ID”.

Next, using the acquired value of the work status, the work determination method 21a obtains the determination result for the work performed by the user, corresponding to the extended UI (step S3). In the example shown in FIG. 5, the determination result for the work status “order ID” is “order ID value”, and the determination result is “123456789”.

Next, the work data processing unit 12c accesses the storage unit 21 of the proxy server 20 and acquires a record of the work database that includes the work data 21b of the displayed extended UI for “case personnel” (step S4).

When the operation type is “reference” (“reference” in step S5), the work data processing unit 12c acquires records that match the determination result, using the determination result as a key. Also, the work data processing unit 12c displays the work data 21b of the latest record among a plurality of records that have the same determination result (step S6). In the example shown in FIG. 5 (b), the work data processing unit 12c acquires the record with the determination result “123456789” shown in a thick frame, appropriately formats it according to the purpose of the extended UI, and displays it on the extended UI. In this example, only the work data “Denden Hanako” is extracted and displayed.

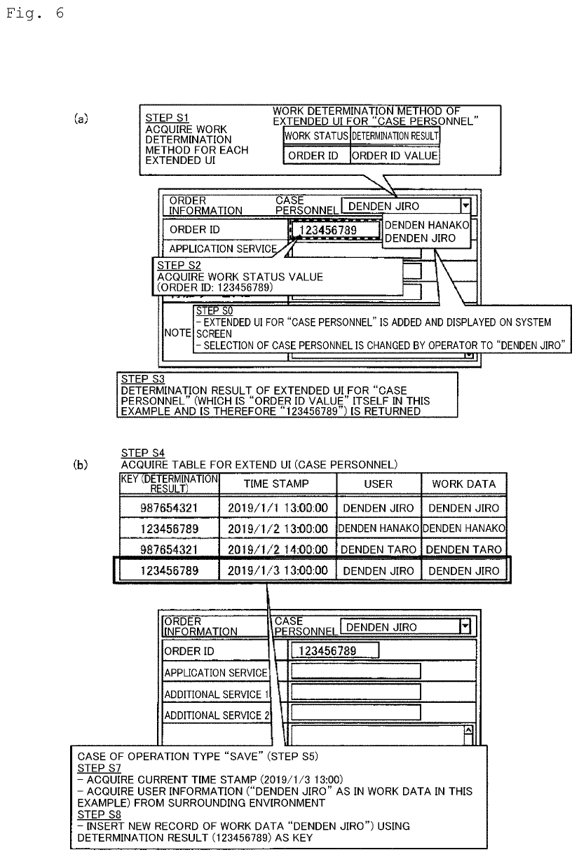

FIG. 6 illustrates processing that is carried out when the operation type of the operation performed by the user on the extended UI for “case personnel” is “save”. First, the user has performed an operation to make an instruction indicating “save” to the extended UI for “case personnel” that is additionally displayed on the system screen by the extension function execution unit 12a (step S0), by performing an input operation to select “Denden Jiro”. In this case, as in the example shown in FIG. 5, the work determination unit 12b acquires the work determination method 21a of the displayed extended UI for “case personnel” from the storage unit 21 of the proxy server 20 (step S1).

Also, the work determination unit 12b acquires the work status value set to the work determination method 21a (step S2). In the example shown in FIG. 6, the work determination unit 12b acquires the value “123456789” of the work status “order ID”.

Next, using the acquired value of the work status, the work determination method 21a obtains the determination result for the work performed by the user, corresponding to the extended UI (step S3). In the example shown in FIG. 6, the determination result for the work status “order ID” is “order ID value”, and the determination result is “123456789”.

Next, the work data processing unit 12c accesses the storage unit 21 of the proxy server 20 and acquires a record of the work database that includes the work data 21b of the displayed extended UI for “case personnel” (step S4).

When the operation type is “save” (“save” in step S5), the work data processing unit 12c acquires the current time (time stamp) and information that identifies the user (step S7). In the example shown in FIG. 6, the work data processing unit 12c acquires the time stamp “2019/1/3 13:00” and the user “Denden Jiro”.

Thereafter, the work data processing unit 12c associates the determination result, the user, and the time stamp with the work data input by the user, transmits them to the proxy server 20, and stores them in the storage unit 21 (step S8). In the example shown in FIG. 6(b), as shown in a thick frame, a record in which the determination result “123456789”, the time stamp “2019/1/3 13:00”, and the user “Denden Taro” are associated with the work data “Denden Jiro” input by the user, is added to the storage unit 21.

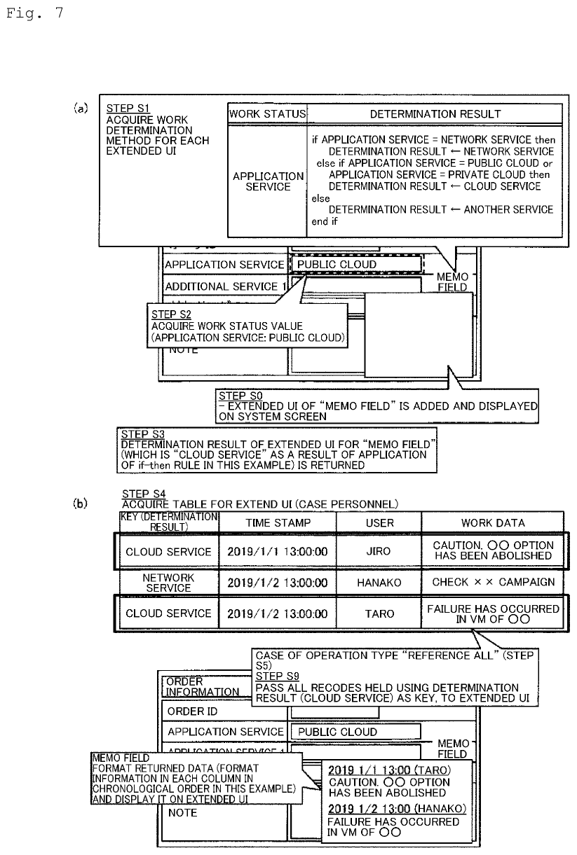

FIG. 7 illustrates processing that is carried out when the operation type of the operation performed by the user on the extended UI for “application service” is “reference all”. First, the user has performed an operation to make an instruction indicating “reference all” to the extended UI that is additionally displayed on the system screen by the extended function execution unit 12a (step S0). In this case, the work determination unit 12b acquires the work determination method 21a of the displayed extended UI for “application service” from the storage unit 21 of the proxy server 20 (step S1).

Also, the work determination unit 12b acquires the work status value set to the work determination method 21a (step S2). In the example shown in FIG. 7, the work determination unit 12b acquires the value “public cloud” of the work status “application service”.

Next, using the acquired value of the work status, the work determination method 21a obtains the determination result for the work performed by the user, corresponding to the extended UI (step S3). In the example shown in FIG. 7, the determination result of the work status “application service” is defined by if-then and is “cloud service”.

Next, the work data processing unit 12c accesses the storage unit 21 of the proxy server 20 and acquires a record of the work database that includes the work data 21b of the displayed extended UI for “application service” (step S4).

When the operation type is “reference all” (“reference all” in step S5), the work data processing unit 12c acquires records that match the determination result, using the determination result as a key. Alternatively, the work data processing unit 12c displays a plurality of pieces of work data 21b that have the same determination result, in chronological order or with a time added thereto (step S9). In the example shown in FIG. 7(b), the work data processing unit 12c acquires the record with the determination result “cloud service” shown in a thick frame, appropriately formats it according to the purpose of the extended UI, and displays it on the extended UI. In this example, the pieces of information in each column are displayed in chronological order.

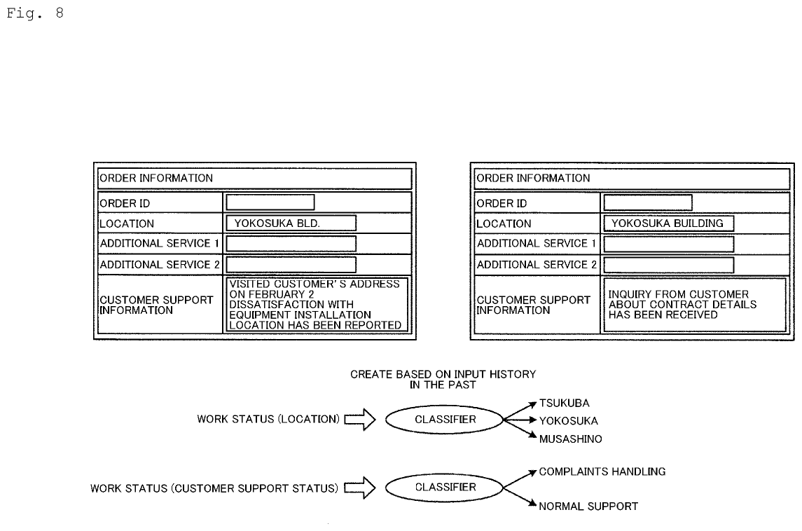

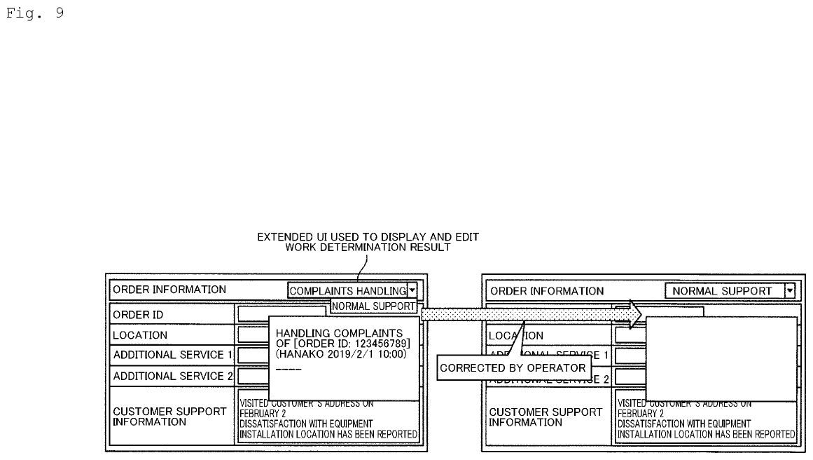

Note that FIGS. 8 and 9 are diagrams illustrating processing that is carried out by the work determination unit 12b. As shown in FIG. 8, the work determination unit 12b may create a classifier for classifying the values of the work status and obtain the work determination result. For example, the work determination unit 12b creates a classifier using the values of the work status and the determination results input to the system in the past, and sets the clustering result of clustering performed by the classifier as the determination result.

As a result, as shown in FIG. 8, the work determination unit 12b can obtain a determination result indicating that the work status “location” is the same location even if the same location is indicated by various building names, for example. In the example shown in FIG. 8, even if the value of the work status “location” varies like “Yokosuka Bld.” and “Yokosuka Building”, the same determination result “Yokosuka” can be obtained.

Alternatively, the work determination unit 12b can specify the customer response status from the content of descriptions in the free description field, and share the content of descriptions between operators for a specific customer response status. In the example shown in FIG. 8, a classifier that classifies the contents of descriptions in the work status “customer support status” into “complaints handling” and “normal support” is used so that the content of descriptions corresponding to “customer support status” corresponding to complaints cases can be shared only between operators for the determination result “complaints handling”.

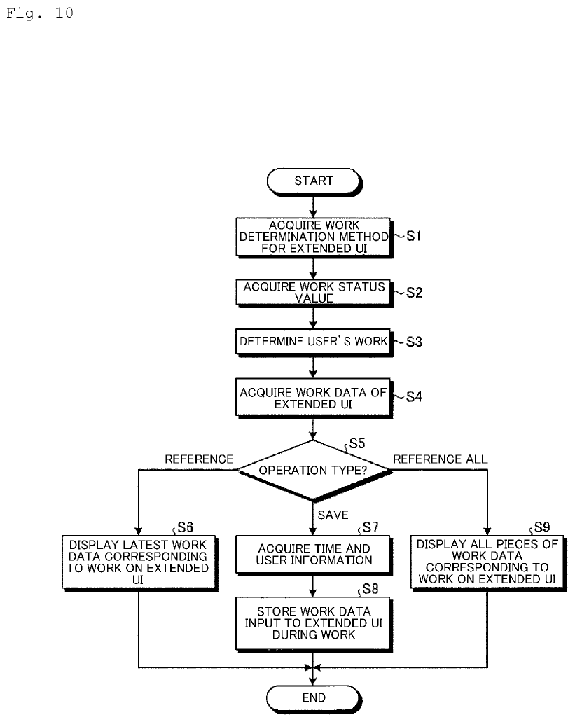

Also, as shown in FIG. 9, instead of determining the work that is carried out by the user, the work determination unit 12b may present candidates for the work and prompt the user to select the work that is carried out by the user. As a result, the work determination unit 12b enables the operator to correct or edit the determination result corresponding to the work when the work does not match the actual work of the operator or the work is not uniquely determined. In the example shown in FIG. 9, an extended UI that displays work determination result and change candidates is additionally displayed so that the operator can modify the determination result by performing edition to change the selection from the candidates.

[Information Linkage Processing] Next, information linkage processing carried out by the information linkage system 1 according to the present embodiment will be described with reference to FIG. 10. FIG. 10 is a flowchart showing information linkage processing procedures. The flowchart in FIG. 10 starts when the user performs an operation to make an instruction to perform reference, save, or reference all, on the extended UI displayed on the screen by the extension function execution unit 12a, according to an instruction from the proxy server 20, for example.

First, the work determination unit 12b acquires the work determination method 21a of the displayed extended UI from the storage unit 21 of the proxy server 20 (step S1). Also, the work determination unit 12b acquires the work status value set to the work determination method 21a (step S2).

Next, using the acquired value of the work status, the work determination method 21a obtains the determination result for the work performed by the user, corresponding to the extended UI (step S3).

Next, the work data processing unit 12c accesses the storage unit 21 of the proxy server 20 and acquires a record of the work database that includes the work data 21b of the displayed extended UI (step S4).

When the operation type is “reference” (“reference” in step S5), the work data processing unit 12c acquires records that match the determination result, using the determination result as a key. Also, the work data processing unit 12c displays the work data 21b of the latest record among a plurality of records that have the same determination result (step S6). Thus, the series of information linkage processing is complete.

When the operation type is “save” (“save” in step S5), the work data processing unit 12c acquires the current time and information that identifies the user (step S7). Thereafter, the work data processing unit 12c associates the determination result, user identification information, and the time with the work data input by the user, and stores the work data in the storage unit 21 of the proxy server 20 (step S8). Thus, the series of information linkage processing is complete.

When the operation type is “reference all” (“reference all” in step S5), the work data processing unit 12c acquires records that match the determination result, using the determination result as a key. Alternatively, the work data processing unit 12c displays a plurality of pieces of work data 21b that have the same determination result, in chronological order or with a time added thereto (step S9). Thus, the series of information linkage processing is complete.

As described above, the information linkage system 1 according to the present embodiment includes the terminal 10 operated by the user and the proxy server 20 that relays communication between the terminal 10 and the web server 30. The storage unit 21 of the proxy server 20 stores, for each extended user interface, a work determination method 21a that is a method for determining a work that is carried out by the user, and work data 21b that has been input to the extended user interface in correspondence with the work. In the terminal 10, the work determination unit 12b acquires the work determination method 21a for an extended user interface that is displayed, from the storage unit 21, and determines the work that is carried out by the user on the terminal 10, according to the work determination method 21a. In addition, the work data processing unit 12c acquires the work data 21b corresponding to the determined work, from the storage unit 21, and displays it on the extended user interface.

Thus, the information linkage system 1 can link information input to the extended UI between a plurality of operators, and improve team productivity.

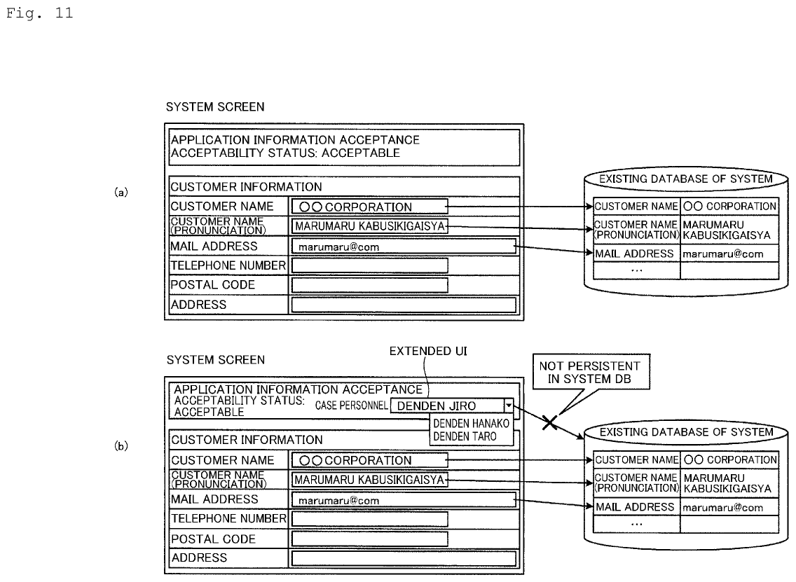

Here, FIGS. 11 to 14 are diagrams illustrating advantages of the information linkage processing according to the embodiment. First, FIGS. 11 to 13 illustrate related technology. As shown in FIG. 11, related technology realizes extension functions by adding an extended UI without modifying the existing system. At this time, the work data input to the extended UI is not stored (persistent) in the database of the existing system such as the existing database of the web server 30. FIG. 11(a) illustrates an existing system screen. In the example shown in FIG. 11(b), an extended UI used to input “case personnel”, which does not exist in the existing system screen shown in FIG. 11(a), is added to the system screen. On the other hand, the name of the case personnel, which is the work data entered here, is not stored in the database of the existing system.

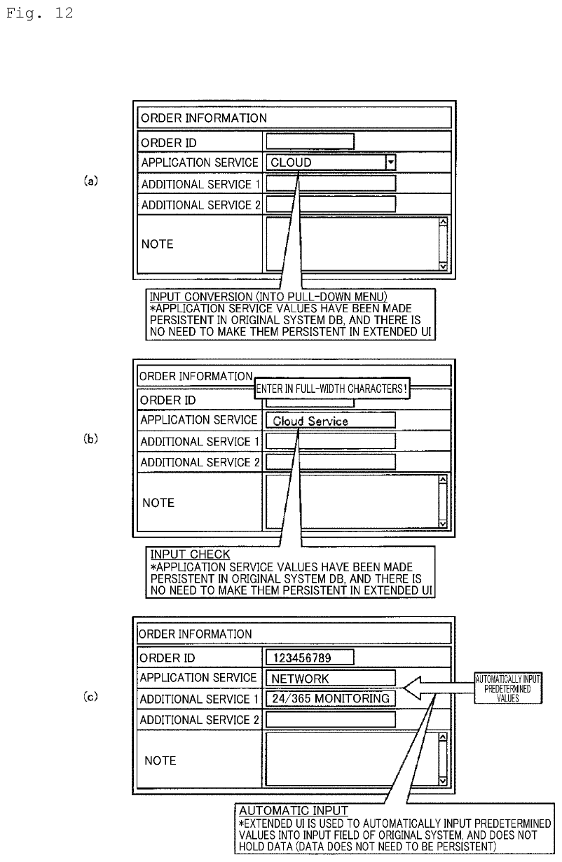

Therefore, as shown in FIG. 12, it is possible to realize extension functions that only need to convert the value stored in the existing system into an easy-to-understand name, such as input conversion, input check, and automatic input. For example, FIG. 12 (a) illustrates an input conversion function that is the function of converting the value of the application service to be selected and input, into “cloud” and displaying it. FIG. 12(b) illustrates an input check function that is the function of converting the input value of the application service into “cloud” and displaying it. FIG. 12(c) illustrates a function of automatically inputting the specified value “network” of the system in the input field.

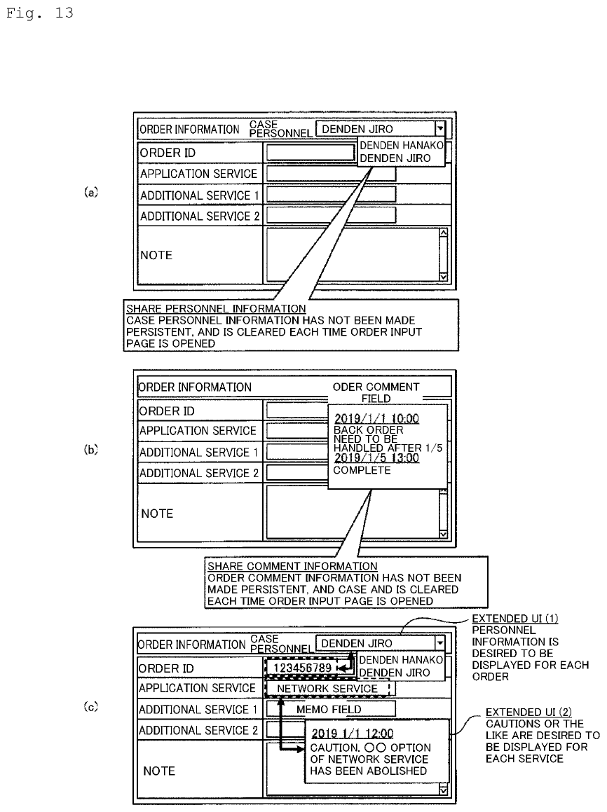

On the other hand, as shown in FIG. 13, it is not possible to realize the extension function that requires persistence in the database of the existing system. For example, as shown in FIG. 13(a), even if “case personnel” is entered in the extended UI, it is not made persistent, and is therefore cleared every time a new order information input page is opened. Also, as shown in FIG. 13(b), even if the operator writes a comment in “order comment field”, it is similarly cleared every time the order information input page is opened.

Also, even if work data input for each extended UI is made persistent without change, it cannot be classified by order or by service as shown in FIG. 13(c). For example, it is not possible to display the name of a case personnel that is different for each order ID in the extended UI for “case personnel”. In addition, it is not possible to display a note or the like entered for each application service on the extended UI for “memo field”.

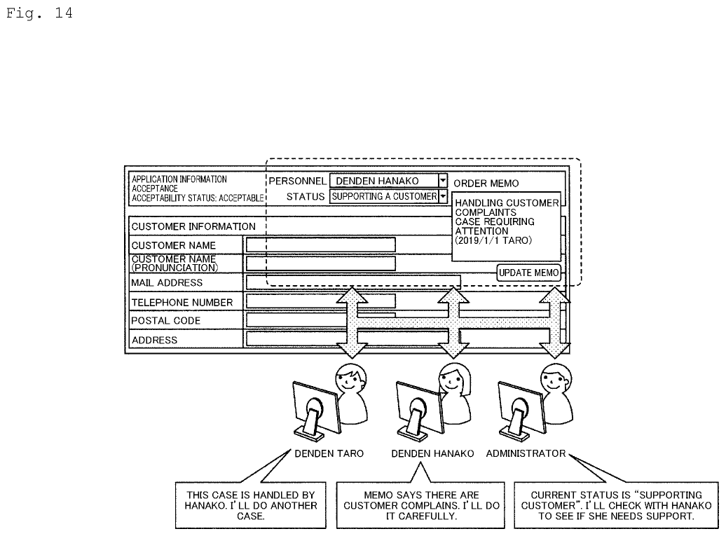

In contrast, as shown in FIG. 14, according to the information linkage processing carried out by the information linkage system 1 according to the present embodiment, the work data entered to the extended UI in the past is appropriately displayed according to the work carried out by the operator. For example, in the example shown in FIG. 14, a supporting personnel, a status such as “supporting a customer”, and an extended UI for an order memo are displayed for each order ID. As a result, the operator can check the fact that an operator other than themselves is supporting the customer, the status of the supporting personnel, and information such as a memo regarding complaints.

In this way, with the information linkage system 1, work data input to the extended UI can be shared between operators according to the work, and therefore it is possible to realize effective information linkage between operators, and improve team productivity.

In addition, the work determination method 21a includes a work status that specifies the surrounding environment of the user, and the work determination unit 12b determines the work performed by the user, using the value of the work status. Also, the surrounding environment is specified by any of, or a combination of: information regarding the terminal 10; information displayed on the screen of the terminal 10; and information regarding another application running on the terminal 10. As a result, the information linkage system. 1 can more accurately determine the work carried out by the user.

Also, the work data processing unit 12c stores, in the storage unit 21 of the proxy server 20, the work data input by the user to the extended user interface during execution of work, in association with the work. As a result, the information linkage system 1 can realize more quick information linkage between operators.

In addition, the work data processing unit 12c stores the work data in the storage unit 21 further in association with information that identifies the user, and time. As a result, the information linkage system 1 can realize more appropriate information linkage between operators according to the work carried out by each operator.

Also, instead of determining the work that is carried out by the user, the work determination unit 12b presents candidates for the work and prompts the user to select the work that is carried out by the user. As a result, the information linkage system 1 can realize more appropriate information linkage between operators according to the work that is carried out.

Note that, when the latest piece of work data of pieces of work data corresponding to the determined work is a piece of work data input by another user, the work data processing unit 12c provides a notification of a change in work data. As a result, the information linkage system 1 can realize more quick information linkage between operators.

[Program] It is also possible to create a program in which processing that is to be executed by the terminal 10 and the proxy server 20 of the information linkage system 1 according to the above embodiment is described in a language that can be executed by a computer. In one embodiment, the terminal 10 and the proxy server 20 can be implemented by installing an information linkage program for executing the above information linkage processing as package software or online software on a desired computer. For example, by causing an information processing apparatus to execute the above information linkage program, it is possible to enable the information processing apparatus to function as the terminal 10 and the proxy server 20 of the information linkage system 1. The information processing apparatus mentioned here may be a desktop or laptop personal computer. In addition, the scope of the information processing apparatus includes mobile communication terminals such as a smartphone, a mobile phone, and a PHS (Personal Handyphone System), and slate terminals such as a PDA (Personal Digital Assistant). Further, the functions of the terminal 10 and the proxy server 20 may be implemented on a cloud server.

Further, as described above, each of the functional units, namely the terminal 10 and the proxy server 20, may be mounted on a different information processing apparatus. For example, the extension function addition unit 22a may be implemented on the terminal 10. Also, the storage unit 21 may be implemented on a proxy server 20 that is different from a proxy server on which the control unit 22 is implemented, or on the web server 30.

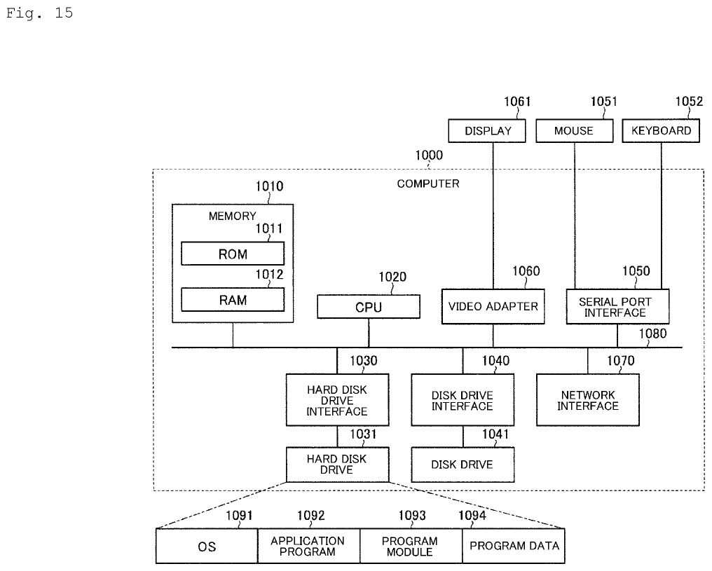

FIG. 15 is a diagram showing an example of a computer that executes an information linkage program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other via a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1031. The disk drive interface 1040 is connected to a disk drive 1041. A removable storage medium such as a magnetic disk or an optical disk is inserted into the disk drive 1041. A mouse 1051 and a keyboard 1052 are connected to the serial port interface 1050, for example. A display 1061 is connected to the video adapter 1060, for example.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

Further, the information linkage program is stored in the hard disk drive 1031 as, for example, a program module 1093 in which commands to be executed by the computer 1000 are written. Specifically, the program module 1093 in which each kind of processing to be executed by the terminal 10 of the information linkage system 1 described in the above embodiment is written is stored in the hard disk drive 1031.

Also, data to be used for information processing carried out by using the information linkage program is stored as the program data 1094 in, for example, the hard disk drive 1031. Thereafter, the CPU 1020 reads out and loads the program module 1093 and the program data 1094 stored in the hard disk drive 1031 to the RAM 1012 when necessary, and executes each of the above-described procedures.

Note that the program module 1093 and the program data 1094 related to the information linkage program are not limited to being stored in the hard disk drive 1031, and may be stored in a removable storage medium, for example, and read out by the CPU 1020 via the disk drive 1041 or the like. Alternatively, the program module 1093 and the program data 1094 related to the information linkage program may be stored in another computer connected via a network such as LAN or WAN (Wide Area Network), and read out by the CPU 1020 via the network interface 1070.

Although an embodiment to which the invention made by the inventors is applied has been described above, the present invention is not limited by the description and the drawings that form a part of the disclosure of the present invention according to the present embodiment. That is to say, other embodiments, examples, operational techniques, and the like made by those skilled in the art based on the present embodiment are all included in the scope of the present invention.

### REFERENCE SIGNS LIST

1 Information linkage system
10 Terminal
11 Storage unit
12 Control unit
12a Extension function execution unit
12b Work determination unit
12c Work data processing unit
20 Proxy server
21 Storage unit
21a Work determination method
21b Work data
22 Control unit
22a Extension function addition unit
30 web server

1. An information linkage system comprising:
processing circuitry configured to:
store, for each extended user interface, a work determination method that is a method for determining a work that is carried out by a user, and work data that has been input to the extended user interface in correspondence with a work;
acquire the work determination method for an extended user interface that is displayed, from a storage, and determine the work that is carried out by the user on a terminal that is operated by the user, according to the work determination method; and
acquire the work data corresponding to the work thus determined, from the storage, and display the work data on the extended user interface.

2. The information linkage system according to claim 1,
wherein the work determination method includes a work status that specifies the user's surrounding environment, and
the processing circuitry is further configured to use a value of the work status to determine the work.

3. The information linkage system according to claim 1, wherein the processing circuitry is further configured to store, in the storage, work data input by the user to the extended user interface during execution of the work, in association with the work.

4. The information linkage system according to claim 3, wherein the processing circuitry is further configured to store the work data in the storage further in association with information that identifies the user, and time.

5. The information linkage system according to claim 2, wherein the surrounding environment is specified by any of, or a combination of: information regarding the terminal, information displayed on a screen of the terminal, and information regarding another application running on the terminal.

6. The information linkage system according to claim 1, wherein, instead of determining the work that is carried out by the user, the processing circuitry is further configured to present candidates for the work and prompt the user to select the work that is carried out.

7. The information linkage system according to claim 4, wherein, when a latest piece of work data of pieces of work data corresponding to the determined work is a piece of work data input by another user, the processing circuitry is further configured to provide a notification of a change in work data.

8. An information linkage method comprising:
storing, for each extended user interface, a work determination method that is a method for determining a work that is carried out by a user, and work data that has been input to the extended user interface in correspondence with a work;
acquiring the work determination method for an extended user interface that is displayed, from a storage, and determining the work that is carried out by the user on a terminal that is operated by the user, according to the work determination method; and
acquiring the work data corresponding to the work thus determined, from the storage, and displaying the work data on the extended user interface, by processing circuitry.
